(19) United States
(12) Patent Application Publication
(10) Pub. No.: US 2025/0168220 A1
(43) Pub. Date: May 22, 2025

(54) SYSTEMS AND METHODS FOR MONITORING API USAGE BY APPLICATIONS IN A DISTRIBUTED COMPUTING ENVIRONMENT

(71) Applicant: Alexandru Emilian Lazarescu, Vienna (AT)

(72) Inventor: Alexandru Emilian Lazarescu, Vienna (AT)

(21) Appl. No.: 18/943,265

(22) Filed: Nov. 11, 2024

Related U.S. Application Data
(60) Provisional application No. 63/600,120, filed on Nov. 17, 2023.

(51) Int. Cl. H04L 67/025; H04L 67/10

(52) U.S. Cl. CPC H04L 67/025; H04L 67/10

(57) ABSTRACT

Methods and systems for determining, presenting and analyzing API usage of an application are disclosed herein. Embodiments of an API monitor as presented herein may serve to provide tightly coupled insight into API usage by an application to ascertain and provide knowledge and visibility into API usage by an application associated with the API monitor, including API calls made by both a frontend and a backend of an application.

### RELATED APPLICATION(S)

This application claims a benefit of priority under 35 U.S.C. 119 to U.S. Provisional Patent Application Ser. No. 63/600,120 filed Nov. 17, 2023, entitled “SYSTEMS AND METHODS FOR MONITORING API USAGE BY APPLICATIONS IN A DISTRIBUTED COMPUTING ENVIRONMENT,” which is hereby incorporated herein for all purposes.

### TECHNICAL FIELD

This disclosure relates generally to distributed networked computer environments and, more particularly, to monitoring use of application programming interfaces by applications in such a distributed networked computer environment.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Ever since the advent of computer networks (including the Internet), enterprise environments have been steadily growing more complicated. Enterprise computing environments thus operate on interconnected computing devices to support and manage business needs, provide resources, deliver services, and provide interactive web services among other things. The various distributed applications, services, processes, servers or other hardware or software infrastructure components comprising these enterprise computing environments may thus interact through a variety of interfaces.

Developers of applications that are to be utilized in these distributed computing environments may lack awareness of what interfaces (e.g., for services) can be, or are being, used by applications or their components. Moreover, awareness of these interfaces may not lend any insight into when, why, or how such interfaces are being used (e.g., in association with a particular application or component).

This is especially true given that providers of these services (e.g., that may be accessed through these interfaces), may find it difficult to expose these interfaces, including functional (or other) settings for an interface. Specifically, disseminating the format or capabilities of such interfaces may prove difficult given the large suite of services that such providers may offer and the capabilities of such services. Thus, developers of these applications may have few avenues to glean detailed information about such interfaces.

Oftentimes then, when developing or using an application or component thereof in a distributed computing environment, including the use or testing of the (e.g., actions of) an application with respect to a suite of interfaces offered in, or by, that computing environment, these users may desire knowledge regarding what interfaces were called by an application (or component thereof), how, when, or why those interfaces were called, and what portions of the application (e.g., components) were associated with those called interfaces

It is thus desirable to provide simple, straightforward, and powerful systems and methods for obtaining, evaluating, and presenting data regarding interfaces that are utilized by an application or component thereof.

### SUMMARY

As discussed, enterprise environments have been steadily growing more complicated. Enterprise computing environments thus operate on interconnected computing devices to support and manage business needs, provide resources, deliver services, provide interactive web services among other things. The various distributed applications, services, process, servers or other hardware or software infrastructure components comprising these enterprise computing environments may thus utilize interfaces (e.g., application programming interfaces (APIs), RESTful interfaces, or other types of interfaces or protocols used in computing environments, which will be collectively referred to herein as APIs without loss of generality). APIs are software methods that allow communication between components of a computing environment. Thus, for a given computing environment there may be a large number of such APIs and the development of components within that computing environment, or use of such a computing environment, may entail the use of, and knowledge regarding such APIs.

However, as a (e.g., software) developer or other user of a computing environment, when working with APIs it is sometimes difficult to locate and consume sample code related to an API that it is desired to use, or to be aware of what APIs are being used by a component or when, why or how such APIs are being used. As an API provider, it is a challenge to expose all the functional (or other) settings for an API and give examples for all the different areas associated with those APIs.

There are some interactive tools where a user can test REST Services and see the result, but they might depend on different actions (like processing a document might depend on the previous creation of that document) and as a result, a user may just see a result of an API call out of context of that API call and the component which generated the API call and uses the result, not as an entire operation.

Oftentimes then, when developing or using a component (e.g., application) in a computing environment, including the use or testing of the (e.g., actions of) a component with respect to a suite of APIs offered in or by that computing environment, these developers or users desire knowledge regarding what API's were called by that component, how, when, or why those APIs were called, and what portions of the component were associated with those called APIs.

In certain cases, for developers there may be different tools like a browser's network tab to analyze the traffic from an application but there are many significant downsides using the network tab. Namely, the network tab and the implementation of the network tab is not tightly integrated with applications (e.g., browser based applications).

It is thus desirable to provide simple, straightforward and powerful systems and methods for obtaining, evaluating and presenting data regarding what API's were called by a component, how, when, or why those APIs were called, and what portions of the component were associated with those called APIs.

To address these desires, among others, methods and systems for determining, presenting and analyzing APIs of an application are disclosed herein. Embodiments of an API monitor as presented herein may serve to provide tightly coupled insight into API usage by a component (e.g., referred to as an application herein without loss of generality) to ascertain and provide knowledge and visibility into API usage by a component associated with the API monitor.

According to embodiments, an API monitor may provide a display or list of APIs in association with an application, where those APIs are the APIs called by the application. The displayed APIs may be restricted to a suite of APIs offered by an enterprise or a subset or class of such APIs and the APIs listed may be filtered by a wide variety of criteria, including those subsets or classes. Moreover, the APIs may be updated and displayed dynamically as these APIs are called by the underlying application. Additionally, displayed portions of the application associated with those APIs may be highlighted or otherwise associated with the APIs call and may be done so dynamically as the API is called or utilized. The API monitor may also be used to control the calling of those APIs to, for example, impose a delay for the calling of APIs (or between calls to APIs by the application).

Embodiments of the API monitor may thus be adapted to show all the APIs that were called by an application up to a certain point by separately determining and presenting the parameters and the body of API calls. Certain embodiments of an API monitor may capture API calls from both the frontend and backend of an application. Specifically, API call data for API calls from both the frontend and backend of the application associated with the application to the frontend so a user can understand the API calls made by both the frontend and backend of the application.

Embodiments of an API monitor may set or impose a pause (e.g., time delay) so that each (or a set of) API calls of the application is delayed for a time period before being sent or utilized. Such a capability may be very useful when an action in a user interface of an application calls multiple services (e.g., and they run very fast).

Embodiments of an API monitor may set a border or other highlighting or designation (e.g., so that components in a user interface of an associated application will have a border while calling an API)—in this way a user can know which component or portion of the application or interface is calling which API.

Embodiments of an API monitor can store response to these API calls so that the user can review the (e.g., raw or entire) response returned in response to an API call, even those API calls that occurred by an application before the API monitor was accessed or opened.

The API monitor can also include a direct link to documentation of one or more API calls presented in an interface of the API monitor.

Embodiments of an API monitor may also be adapted to export API calls or associated information into Postman or another development, or into a workflow application, such as those in which a user of the development application can reissue the same calls or share it with other people. The export of an API call of the associated information may include all the dependencies (e.g., tokens, authentication calls, etc.) of that API call. The API monitor can also be used to make the export of the API call more generic (e.g., creating variables for URL, tenantID, etc.). so they can be shared with other users (e.g., that have different settings or identifiers, etc.)

Accordingly, embodiments may be directed to techniques, methods, and systems for exposing the use of services and API calls in software processes and applications. More particularly, according to embodiments an API call is executed to a service and a response to the API call is received (from the service) at an application. An API monitoring component intercepts the API call and exposes the API calls, displaying at a graphical user interface component information identifying the API call and service information. In some embodiments, the monitoring component defines data received at the application in response to the API call and such data is displayed at the graphical user interface.

Embodiments of the API monitor component may be configured to intercept one or more API calls to an API provider. In this way, the API monitor component exposes only those API calls provided by the API provider. Advantageously, the monitor component allows users, who may be application developers or designers, to identify the API calls issued to the API provider and better understand the integration of services offered and provided by the API provider. In some embodiments, the monitor component is configured to expose the API calls of a set of API providers, including those leveraged by an application under development or in use in a demonstration, testing, or deployment of an application.

In some embodiments, an application user may toggle on and off (e.g., activate or deactivate) the API monitor component. The monitor component may be configured to delay an API call, so that the identifications of API calls in the graphic user interface may be spaced for more effective presentation to the user. The API call may be delayed, in one non-limiting example, by 2500 microseconds (2.5 seconds) so that a first API call is displayed and 2500 microseconds later a second API is called and displayed.

In still other embodiments, the API monitor component is configured to expose a set limit of API calls for computing efficiencies. The API calls may be recorded and exported for analysis. As described above, data provided to and returned from the API call may be recorded. In further embodiments, the graphical user interface for the monitor component may be displayed alongside an instance of an executed application. In such embodiments, the API monitor component may be configured to annotate the application interface to denote a portion of the application currently being executed. Such annotation may include a border box displayed around the portion or portions of the application relevant to an API call.

In some embodiments, the API monitor component comprises display of a call method, such as but not limited to a Get, Post, Delete, Patch type of call, the name of the API call microservice of the API provider, a uniform resource locator, a documentation link, and other details related to the API call. The API monitor component may also include the parameters of the API call, a payload, headers, and a response status or code, such as but not limited to whether the call was a success or failure/error.

Embodiments of the API monitor component may poll backend applications that themselves may leverage microservices of the API provider. Here, the API monitor component polls one or more backend applications to receive and identify API calls and receive responses and data. Such identified API calls may be displayed along with the API calls directly called by an application.

In still other embodiments, an external trigger is configured to execute a backend application, which issues API calls, for which the API monitor component polls or the external trigger informs the API monitor component that an API call has been executed.

In some embodiments, the API monitor component may be embedded within an application to enable the API monitor component to intercept and expose the API calls of an API provider. In certain cases then, a developer may build an application “around” the monitor component in such a way that as services of the API provider are incorporated (via the API calls of the API provider) the API monitor component will automatically identify and expose the API calls (and services). In other embodiments, the API monitor component is itself a service, which once included in an application, enables the ability to identify, track, and expose services of the API provider.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts one embodiment of a network topology including an application comprising one embodiment of an API monitor.

FIG. 2A depicts one embodiment of an interface including an interface for an API monitor and an associated application interface.

FIG. 2B depicts one embodiment of an interface for an API monitor including options that may be provided for an API monitor.

FIG. 2C depicts one embodiment of an interface for an API monitor including data that may be provided for an API call in an API monitor interface.

FIGS. 3A-3D (collectively FIG. 3) depicts one embodiment of an interface for an API monitor along with corresponding API call data that may be stored for the example API calls depicted in that interface.

FIGS. 4, 5, and 6 depict embodiments of methods for an API monitor.

### DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions or rearrangements within the spirit or scope of the underlying inventive concept will become apparent to those skilled in the art from this disclosure.

Before delving into embodiments in more detail some additional context may be helpful. Ever since the advent of computer networks (including the Internet), enterprise environments have been steadily growing more complicated. Enterprise computing environments thus operate on interconnected computing devices to support and manage business needs, provide resources, deliver services, and provide interactive web services, among other things. The various distributed applications, services, process, servers or other hardware or software infrastructure components comprising these enterprise computing environments may thus utilize interfaces (e.g., application programming interfaces (APIs), RESTful interfaces, or other types of interfaces or protocols used in computing environments, which will be collectively referred to herein as APIs without loss of generality). APIs are software methods that allow communication between components of a computing environment.

Thus, for a given computing environment there may be a large number of such APIs and the development of components within that computing environment, or use of such a computing environment, may entail the use of, and knowledge regarding, such APIs. For example, a particular enterprise environment provider may provide a number of different services (sometimes referred to as microservices), where each of these services may have one or more corresponding APIs.

As a (e.g., software) developer or other user of a enterprise computing environment, when working with APIs it is sometimes difficult to locate and consume sample code related to an API that it is desired to use, or to be aware of what APIs are being used by a component, or when, why or how such APIs are being used. As an API provider (e.g., a service provider in an enterprise computing environment where that service is exposed through an API), it is a challenge to expose all the functional (or other) settings for an API and give examples for all the different areas associated with those APIs.

There are some interactive tools where a user can test (e.g., REST) services and see a result, but these results might depend on different actions (like processing a document might depend on the previous creation of that document). As a result, a user may just see a result of an API call without respect to the context of that API call and the component which generated the API call and uses the result, not as an entire operation.

Oftentimes then, when developing or using a component (e.g., application) in a computing environment, including the use or testing of the (e.g., actions of) a component with respect to a suite of APIs offered in or by that enterprise computing environment, the developers or users desire knowledge regarding what APIs were called by that component; how, when, or why those APIs were called; and what portions of the component were associated with those called APIs. It may be difficult, if not impossible, to determine such information regarding (e.g., only) APIs provided by a particular API provider (such as an API provider that provides a suite of services in an enterprise computing environment).

In certain cases, for developers there may be different tools to analyze traffic from an application (e.g., like a browser's “Network” tab for browser based applications) but there are many significant downsides to using such a tool. First, these tools may not be tightly integrated with an application being executed, thus the use of these types of tools will show all actions of an application or an interface thereof, (e.g. fetching resources like JavaScript files, images, HTML pages, etc.) and the use of (e.g., all or other) APIs, not just desired APIs such as the suite of API calls provided in association with a particular enterprise environment.

Additionally, these types of tools (e.g., a Network tab) typically cannot keep track of previous API calls, only API calls that are initiated or occur after the tool is opened or activated. Thus, to obtain data on these previous API calls, an application may need to be rerun and all the previous actions duplicated (e.g., redone) to see such calls. Moreover, the APIs presented by such tools (e.g., a Network tab) are difficult, if not impossible, to link with documentation (e.g., for an API) so that a seamless experience for the user can be provided, including a direct link to documentation for an API based on application's use of that API.

Importantly, the use of these types of tools (e.g., Network tab) may also only capture and show API calls made by the frontend of an application that go over ports or connections of that application accessible by a separately executing application (e.g., and that are unencrypted), namely the separately executing application implementing that tool (e.g., the Network tab). To illustrate in more detail, applications executing on a computing device (e.g., browser based applications) may issue API calls in a variety of ways. The manner in which an application may issue these API calls may be related to the architecture of these applications.

In some cases, an application (e.g., a browser based application) may comprise multiple portions or components, with a frontend component of the application (referred to as just the frontend or frontend application) residing at the computing device (e.g., executing in association with a browser on the device) where the application is utilized by the user through interaction with this frontend component (e.g., an interface presented by the frontend component). The frontend component of the application may thus issue API calls (e.g., directly from the frontend component) to an API provider (e.g., a service provider in an enterprise computing environment) to interact with services offered by the API provider. The frontend API calls may, for example, be issued based on a user interaction with an interface of the frontend component.

The application may also comprise a backend component of the application (referred to as just the backend or backend application) residing at a physical or virtual server, cloud based computing environment, etc. The backend component may offer one or more interfaces through which the frontend application may access services, data or other functionality offered by the backend component. These may be for services or functionality that requires certain types of applications, or for tasks that may require relatively more processing time or power. The frontend component can thus interact with these interfaces provided by the backend component in implementing the application by sending requests to the backend application through these backend interfaces.

In servicing these backend requests (e.g., to provide a response to the frontend application), the backend application may also issue API calls to an API provider. This API provider may be a same API provider to which the frontend directly issues API calls, may be a different API provider or may include both the same and different API providers. Thus, these API calls issued by the backend application component to service the requests from the frontend component of the application are API calls involved in the provisioning of the application.

As noted above, certain tools for capturing calls of an application (e.g., a Network tab) may only capture and show API calls made by the frontend of an application that go over ports or connections of that application accessible by a separately executing application. Accordingly, these tools may fail to capture or show API calls for the application that originate from the backend of the application. Moreover, any API calls that cannot be monitored by a separately executing application (e.g., because it is sandboxed from a browser in which the application is executing) may also fail to be captured or shown by these tools.

It is therefore desirable to provide simple, straightforward and powerful systems and methods for obtaining, evaluating and presenting data regarding what API's were called by a component, how, when, or why those APIs were called, and what portions of the component were associated with those called APIs.

To address these desires, among others, methods and systems for capturing, determining, presenting and analyzing APIs utilized by an application are disclosed herein. Embodiments of an API monitor as presented herein may serve to provide tightly coupled insight into API usage by a component (e.g., referred to interchangeably as an application herein without loss of generality) to ascertain and provide knowledge and visibility into API usage by a component associated with the API monitor.

According to embodiments, an API monitor may capture API calls associated with an application. In particular, embodiments may capture API calls from both the frontend and backend of an application. Specifically, in certain embodiments the API monitor may include a frontend API monitor component that is incorporated with the application whose API usage it is desired to monitor. This frontend API monitor component may include a calling component adapted to be the component used by all other components of the application to issue frontend API calls from the frontend to an API provider.

When the calling component of the frontend monitor component receives an API call to issue to the API provider, the calling component may create an entry corresponding to this API call (e.g., in frontend API call storage at the frontend API monitor component, such as an array, or other data structure or storage format). When an API call entry is created by the calling component, the calling component may store API call data for the API call in the API call entry. The calling component may also issue the API call (e.g., send a request corresponding to the API call to the API provider).

In some embodiments, the calling component may filter the API calls to determine if an API call entry should be created for that API call. For example, API call entries may only be created for API calls to certain domains (e.g., domains associated with certain API providers such as particular enterprise computing environments) or API call entries may only be created for API calls of a certain type.

When a response is received to an API call, this response may be received by the calling component of the frontend API monitor component that issued the API call. The calling component may thus also store API data corresponding to the response to the API call in the API call entry corresponding to the API call which generated that response. This API data may include (e.g., the entire) response to the API call so that the user can review a raw response returned in response to an API call, including those API calls that occurred by the application before the API monitor is accessed or opened by a user.

Additionally, during operation of the frontend application, requests may be issued by the frontend application to the backend application (e.g., through an backend interface for that application). This request may be, for example, a service provided by the backend application. In association with providing this service, the backend application may issue one or more API calls to an API provider.

The backend application API monitor may include a backend API monitor component that is incorporated with the (e.g., backend portion of the) application whose APIs it is desired to monitor. This backend API monitor component may also include a calling component adapted to issue API calls from the backend application to an API provider in association with the execution of the application (e.g., to provide data or a service).

It will be noted that such API calls to an API provider may be initiated based on a request received from the frontend application through an application interface of the application associated with the backend application, such as for example, implementing a requested service, retrieving requested data, authenticating a user, etc. Such API calls from the backend application in association with implementing the application (e.g., in association with a particular instance of the frontend application) may be generated asynchronously to the operation of the frontend application and may be caused by a variety of circumstances, such as the expiration of a timer, the reception of certain data (e.g., an email), or some other trigger for an API call to an API provider.

When the calling component of the backend monitor component receives an API call to issue to the API provider, the calling component of the backend monitor component may create an entry corresponding to this API call (e.g., in an backend API call storage at the backend API monitor component such as an array of other data structure or storage format). When an API call entry is created by the calling component in backend API call storage, the calling component may store API call data for the API call in the API call entry. The calling component may also issue the API call (e.g., send a request corresponding to the API call to the API provider). As with the frontend calling component, the backend calling component of the backend API monitor may filter these API calls such that API call entries may be created for only API calls to a particular API provider or for a particular type of API calls, etc.

Thus, when a response is received to an API call from the API provider at the backend application, this response may be received by the calling component of the backend API monitor component that issued the API call. The backend calling component may also store API data corresponding to the response to the API call in the API call entry in backend API call storage corresponding to the API call which generated that response. Again, in some embodiments, this API data may include (e.g., the entire) response to the API call so that the user can review a raw response returned in response to an API call, including the entirety of an API call or response to that call that was conducted through the backend of the application, allowing users visibility into these backend API calls.

Accordingly, the frontend API monitor component at the frontend application may obtain API call entries associated with the application from backend API call storage. In some embodiments, the frontend API monitor component may include a backend API call retriever. At some interval, or when prompted through a user (or other type of) action at the frontend application, the backend API call retriever may send a request to an API monitor interface provided by the backend application. For example, such a call may be sent when a user interacts with (or opens) an interface of the API monitor at the user device on which the front end application is being generated.

The request for the backend API retriever may, for example, request API call entries associated with a particular instance of a frontend application (e.g., it may identify the frontend application, instance thereof or user association therewith). In response to receiving such an API call entry request at the API monitor interface, the backend application may obtain the API call entries in backend API call storage associated with the received request (e.g., associated with the a particular instance of a frontend application) and return these API call entries to the backend API call retriever at the frontend application. The backend API call retriever can then store these API call entries in frontend API call storage at the frontend application (e.g., in association with the API call entries created by the calling component of the frontend API monitor.

Thus, the user may interact with the API monitoring interface to obtain or otherwise interact with data on API calls associated with a frontend application being monitored by the API monitor. For example, the API monitor may be adapted to present an (API monitor) interface. This API monitor interface may be presented in association with the interface of the application.

Thus, the API monitor may obtain API call entries from frontend API call storage and present API calls made in the backend or the frontend of the associated application in the API monitor interface. In particular, as the API monitor will maintain API call storage array API call comprising entries corresponding to API calls from the frontend and the backend of the application, the presented API calls in the API monitor interface may include API calls from both the frontend (e.g., all calls going out based on the user interface or interaction with the user interface) as well as the backend (calls that a frontend developer or other user would not normally see in the developer tools of the browser as discussed previously.)

Moreover, API calls from the backend of the application may be presented in the API monitor interface inline with the other APIs calls or may be presented separately such that the user can discern which of the API calls are from the frontend of the backend. The API monitor interface may also allow the user to select or determine which API calls are shown in the API monitor interface, including the selection of API calls for different services, calls for different suites or classes of API calls, calls for particular API providers, etc.

As such embodiments may provide a display or list of APIs (e.g., API calls) in association with an application (e.g., in an interface that is a part of, or otherwise displayed in association with an interface of the application) where those APIs are the APIs called by the application. Those APIs calls may include APIs called by a frontend of the application or backend of the application. Moreover, the displayed APIs may be restricted to a suite of APIs offered by one or more API providers (e.g., enterprise service provider) or a subset or class of such APIs and the APIs listed may be filtered by a wide variety of criteria, including those subsets or classes.

Additionally, the APIs presented by an API monitor may be updated and displayed dynamically as these APIs are called by the underlying application. Additionally, displayed portions of the application associated with those API calls may be highlighted or otherwise associated with the API call, and may be done so dynamically as the API is called or utilized by the application. The API monitor may also be used to control the calling of those APIs to, for example, impose a delay for the calling of an API (or between calls to APIs by the application).

Embodiments of the API monitor may thus be adapted to display all, or a subset of the APIs (e.g., of one or more API providers) that were called by an application (e.g., so far). The display of these API calls by an API monitor interface may present each of the API calls separately and may separate the parameters and the body of an API call. The API monitor can set a border or other highlighting or designation so that components in a user interface of an associated application will be highlighted in association with an API call selected in the API monitor interface—in this way a user can know which component or portion of the application or interface is calling which API.

The presentation of an API call in an API monitor interface may also include a direct link to documentation of one or more API calls presented (e.g., documentation provided by the API provider) The display of these API calls may be styled to match the documentation styling or application styling so that there is a visual connection presented to the user of the API monitor.

As such, embodiments of an API monitor as described herein may be added to substantially any application desired and may serve as a valuable tool to review or determine the API of the application, to learn about the user of such APIs by an application or to share demo scenarios (as collections) among other uses.

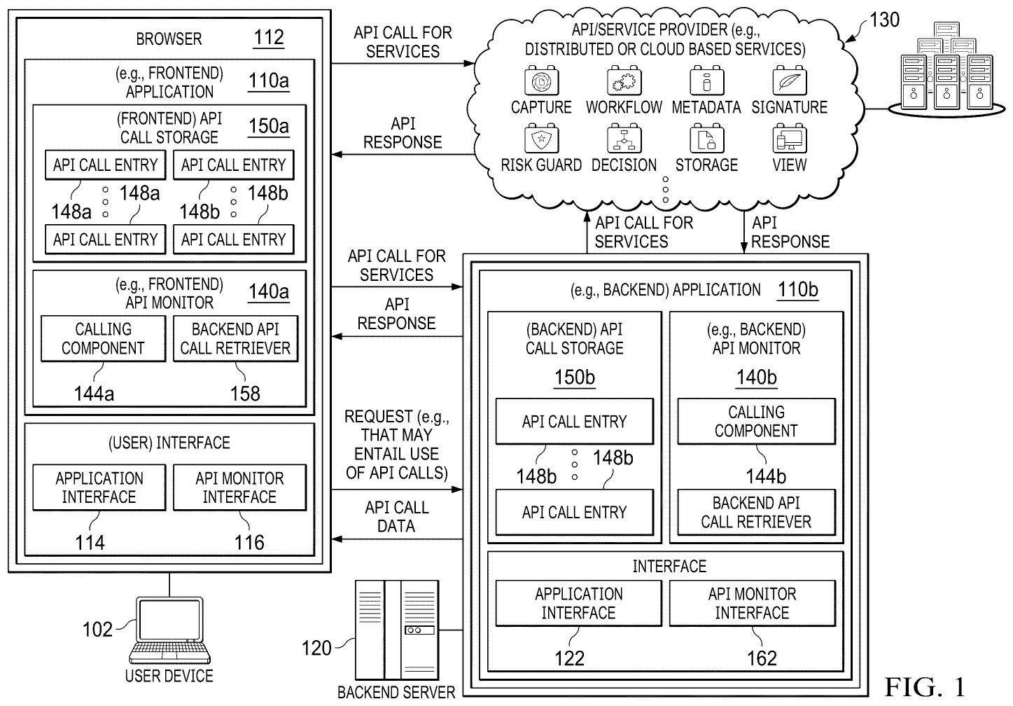

Looking then at FIG. 1, a network topology including an application including one embodiment of an API monitor is depicted. Here, application 110 may include a frontend application 110a (e.g., a frontend portion of the application 110, also referred to as just the frontend or frontend component). The frontend application 110a may be, for example, a browser based application that executes on a browser 112 of a user computing device 102 and presents an application interface 114 through the (interface of) browser 112. Other types of frontend applications 110a may include standalone application executing on an operating system of the user device 102 (e.g., desktop or mobile “apps”), or other types of applications. The user can thus interact with the application 110 through the application interface 114 to access or interact with functionality offered by application 110.

Application 110 may also include a backend application 110b (e.g., a backend portion of the application 110, also referred to as just the backend or backend component). This backend application 110b may reside at a physical or virtual server 120 (e.g., which may be deployed at a cloud based or distributed computing environment, etc.). The backend component 110b may offer one or more interfaces (e.g., a REST interface, etc.) through which the frontend application 110a may access services, data or other functionality offered by the backend application 110b. The services or functionality implemented by backend application 110b may be services or functionality that require certain types of applications, or for tasks that may require relatively more processing time or power. The frontend application 110a can thus interact with a backend application interface 122 provided by the backend application 110b in implementing the application 110 by sending requests to the backend application 110b through these backend interfaces 112.

Application 110 may utilize an API provider 130 to implement certain functionality in association with the application 110. This API provider 130 may be a distributed or cloud based service provider that offers one or more services (e.g., functionality that may be requested) that may be accessed through one or more API interfaces provided by the API provider 130. Accordingly, both frontend application 110a and backend application 110b may send API calls (e.g., requests according to an API offered by API provider 130) in association with providing application 110.

Specifically, application 110 with frontend component 110a and backend component 110b may issue API calls to API provider 130 in a variety of ways. The manner in which an application may issue these API calls may be related to the architecture of these applications. Frontend component 110a of the application 110 may issue API calls (e.g., directly from the frontend component) to API provider 130 to interact with services offered by API provider 130. These frontend API calls may, for example, be issued based on a user interaction with application interface 114 of the frontend application 110a.

Backend application 110b may also issue API calls to API providers associated with providing functionality for application 110. API calls to API provider 130 may be initiated at backend application 110b based on a request received from the frontend application 110a through application interface 122 of the application 110 associated with the backend application 110b such as, for example, implementing a requested service, retrieving requested data, authenticating a user, etc. Such API calls from the backend application 110b may also be generated without initiation from the frontend application 110a and may be caused by a variety of circumstances, such as the expiration of a timer, the reception of certain data (e.g., an email) at backend application 110b, or some other trigger for an API call to an API provider 130.

Application 110 may also include API monitor 140. Specifically, frontend application 110a may include frontend API monitor component 140a and backend application 110b may include backend API monitor component 140b. API monitor 140 may be adapted to provide knowledge and visibility into API usage by application 110. Specifically, API monitor 140 may capture API calls associated with application 110. In particular, frontend API monitor component 140a may capture API calls from the frontend application 110a and backend API monitor component 140b may capture API calls from the backend application 110b. These captured API calls can be displayed by frontend API monitor component 140a in an API monitor interface 116.

In some embodiments, API monitor interface 116 may be displayed in association with application interface 114. Thus, interactions with API monitor interface 116 may cause application interface 114 to change and interactions with application interface 114 may cause API monitor interface 116 to change. For example, API monitor 140 may be adapted to set a border or other highlighting or designation in application interface 114 (e.g., so that components in the user interface 114 of application 110 including API monitor 140 will have a border of a particular color while when an API call in API monitor interface 116 is selected.

According to certain embodiments then, to incorporate API monitor 140 with an application 110, the API monitor 140 can be embedded into a “starter” application (e.g., sometimes referred to as a workbench or skeleton application). In this case, the code of the application 110 will include API monitor 140 which may include a generic calling component 144 which may be a generic application level function to make or run all calls.

This application 110 including the API monitor 140 can then be shared with developers of applications (or others desiring to use the API monitor 140 with their applications) and creators of application 110 may write application code inside this skeleton application. The benefit will be that every call they make using the provided calling component 144 will be able to store and show the API's used in association with the API monitor 140. Additionally, by incorporating API monitor 140 in this manner, the API monitor 140 may be easily removed and the functions of application 110 simplified if desired. Alternatively, the API monitor 140 may be kept in the application 110 but can be selectively activated (e.g., for superusers or debuggers).

Thus, frontend API monitor component 140a is incorporated with the frontend application 110a whose API usage it is desired to monitor. This frontend API monitor component 140a may include a calling component 144 adapted to be the component used by all other components of the frontend application 110a to issue frontend API calls from the frontend application 110a to an API provider 130.

When the calling component 144a of the frontend monitor component 140a receives an API call to issue to the API provider 130, the calling component 144a may create an entry 148a corresponding to this API call (e.g., in frontend API call storage 150a at the frontend application 110a. When an API call entry 148a is created by the calling component 144a, the calling component 144a may store API call data for the API call in the API call entry 148a. The calling component 144a may also issue the API call to the API provider 130.

In some embodiments, the calling component 144a may filter the API calls to determine if an API call entry 148a should be created for that API call. For example, API call entries 148a may only be created for API calls to certain domains (e.g., domains associated with certain API providers such as particular enterprise computing environments) or API call entries may only be created for API calls of a certain type. Moreover, in certain cases the calling component 114a may control the calling of those APIs to, for example, impose a delay for the calling of an API (or between calls to APIs by the application). This delay may be configured, for example, through an interaction with the API monitor interface 116.

When a response is received to an API call, this response may be received by the calling component 144a of the frontend API monitor component 140a that issued the API call. The calling component 144a may thus also store API data corresponding to the response to the API call in the API call entry 148a corresponding to the API call which generated that response. This API data may include (e.g., the entire) response to the API call so that the user can review a raw response returned in response to an API call, including those API calls that occurred by the application 110 before the API monitor 140 is accessed or opened by a user.

Additionally, during operation of the frontend application 110a, requests may be issued by the frontend application 110a to the backend application 110b (e.g., through backend interface 122 for that application 110). This request may be, for example, a service provided by the backend application 110b. In association with providing this service, the backend application component 110b may issue one or more API calls to an API provider 130.

The backend application 110b may include a backend API monitor component 140b that is incorporated with the (e.g., backend portion of the) application 110 whose APIs it is desired to monitor. This backend API monitor component 140b may also include a calling component 144b adapted to issue API calls from the backend application 110b to an API provider 130 in association with the execution of the application 110 (e.g., to provide data or a service).

It will be noted that such API calls to an API provider 130 may be initiated based on a request received from the frontend application 110a through an application interface 122 of the application 110 associated with the backend application 110b, such as, for example, implementing a requested service, retrieving requested data, authenticating a user, etc. Such API calls from the backend application 110b in association with implementing the application 110 (e.g., in association with a particular instance of the frontend application 110a) may be generated asynchronously to the operation of the frontend application 110a and may be caused by a variety of circumstances, such as the expiration of a timer, the reception of certain data (e.g., an email), or some other trigger for an API call to an API provider 130.

When the calling component 144b of the backend monitor component 140b receives an API call to issue to the API provider 130, the calling component 140b of the backend monitor component 110b may create an entry 148b corresponding to this API call (e.g., in backend API call storage 150b at the backend API monitor component 140b. When an API call entry 148b is created by the calling component 144b in backend API call storage 150b, the calling component 144b may store API call data for the API call in the API call entry 148b. The calling component 144b may also issue the API call to the API provider 130. As with the frontend calling component 144a, the backend calling component 144b of the backend API monitor 140b may filter these API calls such that API call entries 148b may be created for only API calls to a particular API provider 130 or for a particular type of API calls, etc.

Thus, when a response is received to an API call from the API provider 130 at the backend application 110b, this response may be received by the calling component 144b of the backend API monitor component 140b that issued the API call. The backend calling component 140b may also store API data corresponding to the response to the API call in the API call entry 148b in backend API call storage 140b corresponding to the API call which generated that response. Again, in some embodiments, this API data may include (e.g., the entire) response to the API call so that the user can review a raw response returned in response to an API call, including the entirety of an API call or response to that call that was conducted through the backend of the application 110, allowing users visibility into these backend API calls.

Accordingly, frontend API monitor component 140a at the frontend application 110a may obtain API call entries 148b associated with the application 110 from backend API call storage 150b. In some embodiments, frontend API monitor component 140a may include backend API call retriever 158. At some interval, or when prompted through a user (or other type of) action at the frontend application 110a, the backend API call retriever 158 may send a request to API monitor interface 162 provided by the backend application 110b. For example, such a call may be sent when a user interacts with (or opens) an API monitor interface 116 of the API monitor 140 at the frontend application 110a or may be sent at particular time intervals when frontend application 110a is running, etc. API call entries 148b may also be pushed to frontend API monitor 140a by backend API monitor 140b (e.g., at a time interval or based on a certain number of API call entries 148b being stored, etc.).

The request from the backend API call retriever 158 may, for example, request API call entries 148b associated with a particular instance of a frontend application 110a (e.g., it may identify the frontend application 110a, instance thereof or user association therewith). In response to receiving such an API call entry request at the API monitor interface 162, the backend application 110b may obtain the API call entries 148b in backend API call storage 150b associated with the received request (e.g., associated with the a particular instance of a frontend application 110a) and return these API call entries 148b to the backend API call retriever 158 at the frontend application. The backend API call retriever 158 can then store these API call entries 148b in frontend API call storage 150a at the frontend application 110a (e.g., in association with the API call entries 148a created by calling component 144a of the frontend API monitor 140a).

The user may interact with the API monitoring interface 116 to obtain or otherwise interact with data on API calls associated with a frontend application being monitored by the API monitor. As the user interacts with API monitoring interface API 116, frontend API monitoring component 140a can obtain API data on API calls from API entries 148 in API call storage 150a at the frontend to present such data on APIs utilized by application 110 through API monitor interface 116.

Specifically, the API monitor 140a may obtain API call entries 148 from frontend API call storage 150a and present API calls made in the backend or the frontend of the associated application 110 in the API monitor interface 116. API monitor interface 116 may be adapted to present API calls from the backend of the application 110 in the API monitor interface 116 inline with the other APIs calls, or present such calls separately. In this manner, the user can discern which of the API calls presented in the interface 116 are from the frontend or the backend. The API monitor interface 116 may also allow the user to select or determine which API calls are shown in the API monitor interface 116, including the selection of API calls for different services, calls for different suites or classes of API calls, calls for particular API providers, etc.

Embodiments of the API monitor 140 may thus be adapted to display all, or a subset of the APIs (e.g., of one or more API providers) that were called by an application 110 (e.g., up until that point). The display of these API calls by an API monitor interface 116 may present each of the API calls separately and may separate the parameters and the body of an API call.

Additionally, the APIs presented through API monitor interface 116 may be updated and displayed dynamically as these APIs are called by the underlying application 110. Additionally, displayed portions of the application in application interface 114 associated with those API calls may be highlighted or otherwise associated with the API call as presented in API monitor interface 116, and may be done so dynamically as the API is called or utilized by the application 110.

Embodiments of API monitor 140 may also be adapted to export all, or a subset of the API calls or associated information (e.g., included in API call storage 150) into another application (e.g., in a format that can be utilized by that application). The export of an API call or the associated information may include all the dependencies (e.g., tokens, authentication calls, etc.) of that API call or may include generic parameters. Specifically, in some cases the API monitor can export the API entries 148 in a generic format such as JavaScript Object Notation (JSON) or extensible Markup Language (XML) or with generic or placeholder variables for parameters for the call such as URL, tenantID, etc. In this manner API calls may be shared with other applications, environments or consumers of those API calls (e.g., that have different settings or identifiers, etc.).

For example, the API data for those API calls in API call entries 148 may be exported into a development application (e.g., Postman or the like) such as those in which a user of the development application can reissue the same API calls or share those calls with other users. As another example, the API data for those API call entries 148 may be exported into a workflow designer application or engine or other type of workflow application such that the workflow application may process these exported API calls and generate a (e.g., template for a) workflow based on the exported API calls.

It will be noted here that while embodiments have described using the example of API calls to an API provider in a distributed network, these types of (e.g., REST) API calls are but one example of the types of API calls that may be monitored and displayed in association with embodiments of an API monitor as disclosed. As another example, the same methodology may be applied by embodiments of an API monitor to monitor API calls (e.g., to functions or for the occurrence of events, etc.) associated with libraries or software developer kits (SDKs) such as JavaScript or the like. Here, the calling component within the monitoring component of an application may receive any function or event passed to (or API calls to) that SDK and then forward it for the (e.g., JavaScript) API. The calling component can also store this function in the API call storage with API call data for that call (e.g., the name, input parameters, output, status). This functions similar to the monitoring of (e.g., REST) API calls as discussed.

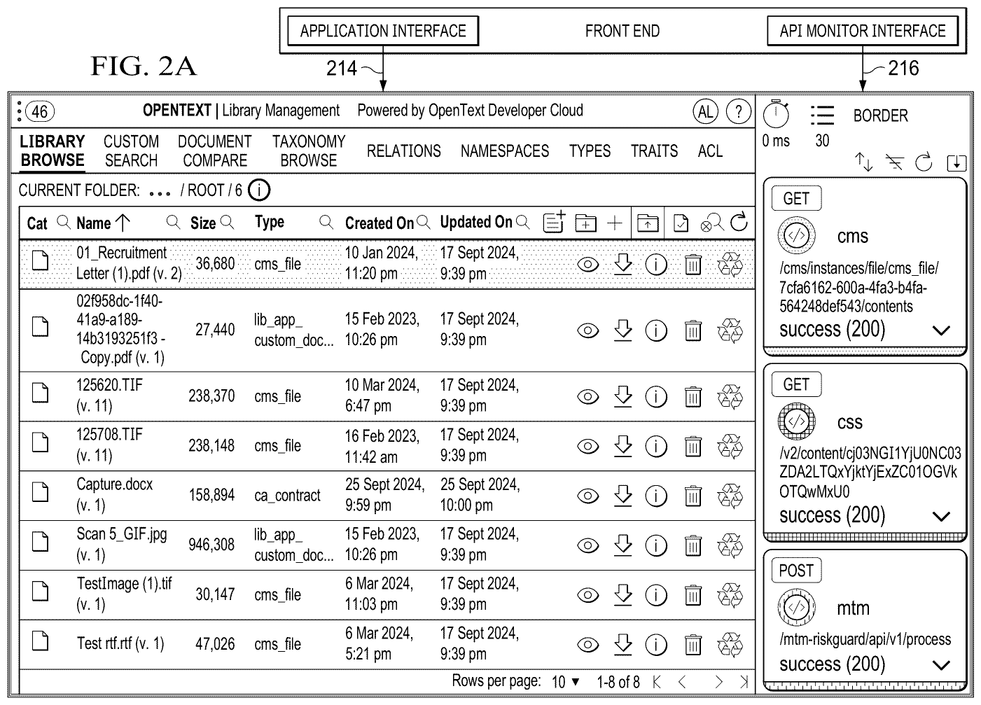

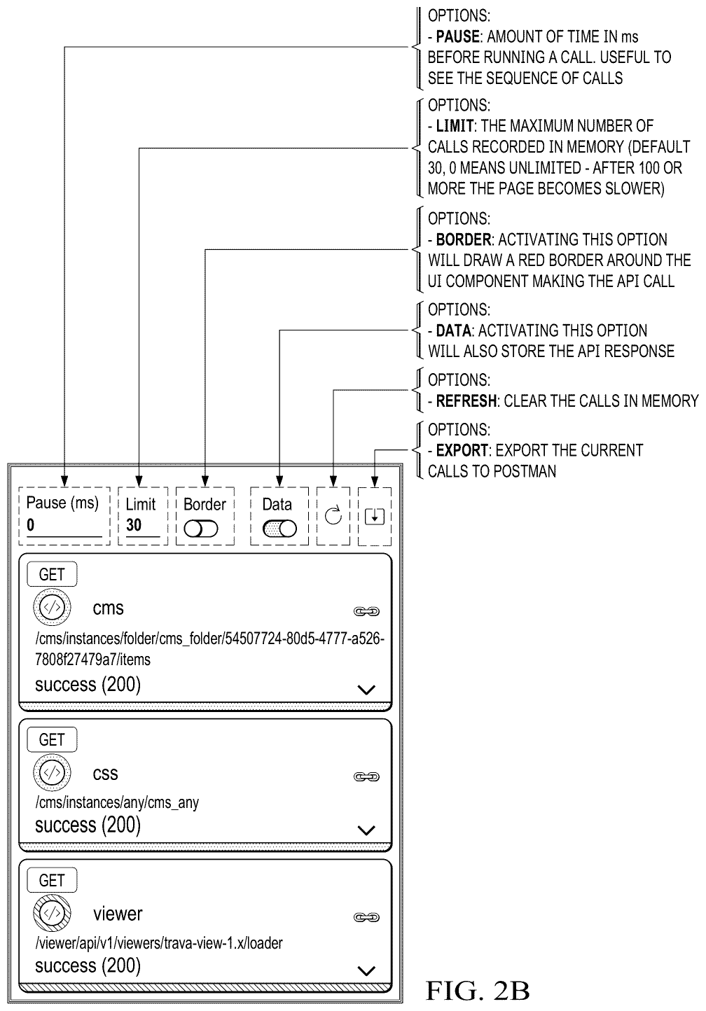

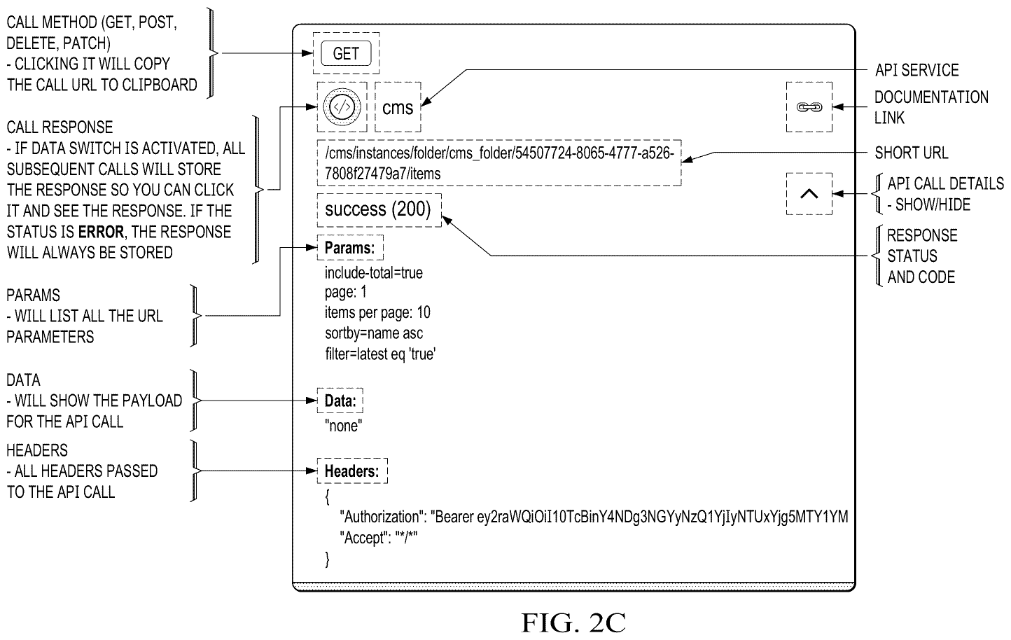

Referring then to FIG. 2A, an example of an interface for one embodiment of an API monitor component is depicted. Here, the interface may include an application interface 214 and an API monitor interface 216, where the API monitor interface 216 depicts API calls made by an application with which it is included and which is presenting application interface 214. FIG. 2B illustrates an example of one embodiment of an API monitor component, where the API monitor interface 214 may allow a user to set options associated with an API monitoring component, including activating options associated with imposing a delay when calling APIs, what data will be stored for APIs associated with the application, which APIs will be stored or shown, etc. FIG. 2C depicts one example of API data that may be stored in a call entry for an API call and displayed in association with that API can in an API monitor interface for an API call. For example, a user may click on or otherwise interact with a particular API call in an API monitor interface and the API monitor interface as depicted in FIG. 2C may be presented.

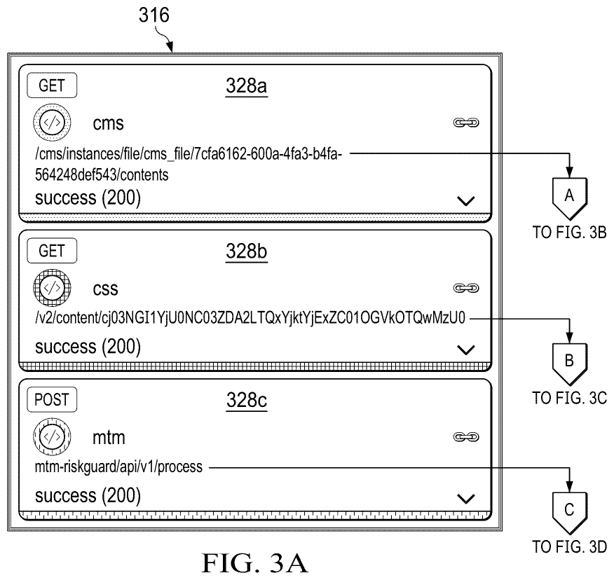

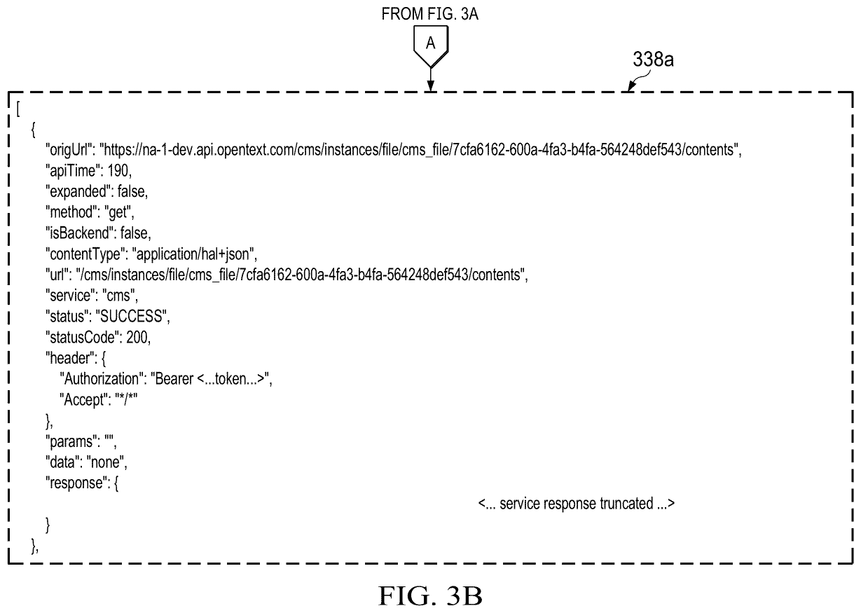

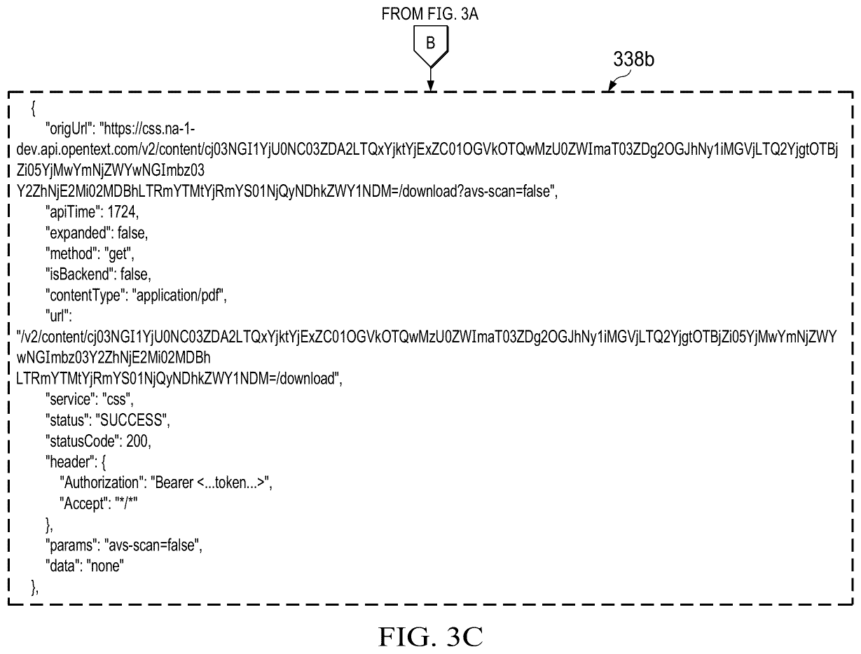

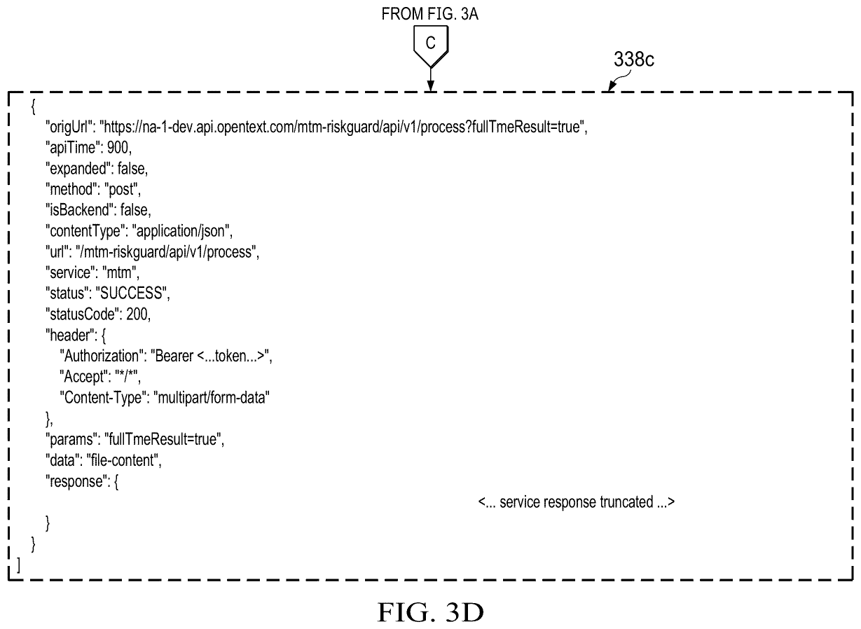

FIG. 3 depicts API data that may be stored by a monitoring component for call entries associated with API calls 310 depicted in the example API monitor interface 216 of FIG. 2A. Here, each API call 328 (e.g., 328a, 328b, 328c) presented in example API monitor interface 316 may be generated from a corresponding API call entry including corresponding API data 338 (e.g., 338a, 338b, 338c).

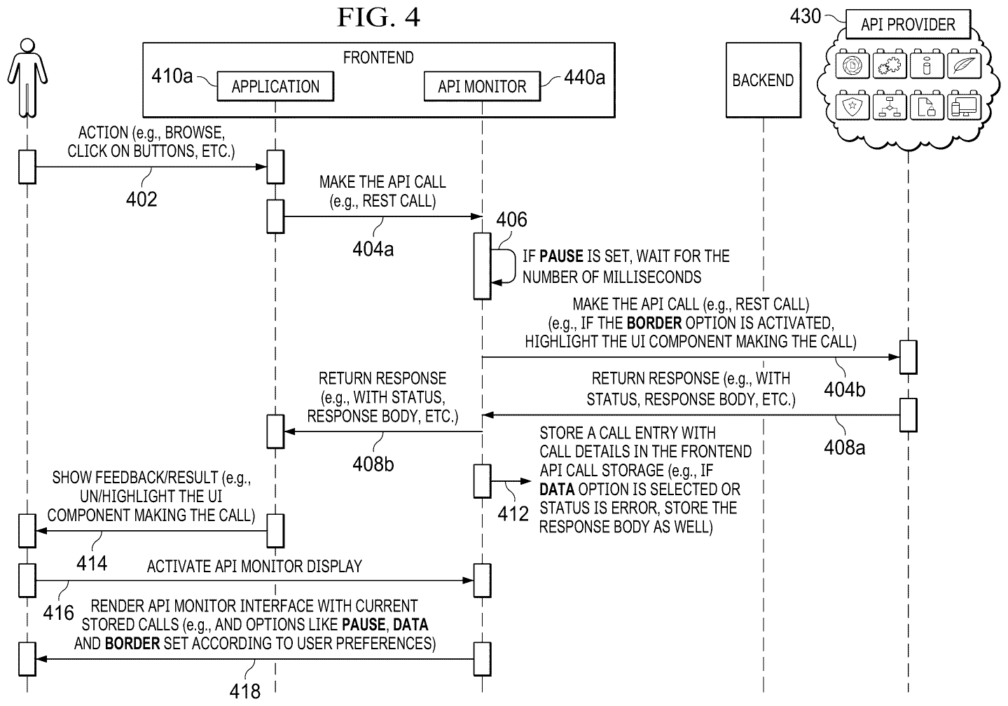

Moving on to FIGS. 4, 5, and 6, flow diagrams are presented for embodiments of methods that may be utilized by an API call monitor for obtaining and presenting API call data for API calls associated with an application. Referring first to FIG. 4, one embodiment of a method for obtaining API call data on API calls from a frontend application 410a (e.g., directly) to an API provider 430 is depicted. Here, frontend API monitor 440a may be incorporated with (or into) frontend application 410a. A user may interact with the frontend application 410a (e.g., using a user interface or the like) (STEP 402). Based on this interaction (or otherwise) frontend application 410a may issue API calls (e.g., directly from the frontend application) to API provider 430 (STEP 404).

API monitor 440a may include a generic calling component which may be a generic application level function to make or run all calls. Therefore, this calling component may be utilized by all components of application 410a for issuing API calls. Therefore, the API call from frontend application 410a may be received at the calling component of API monitor 440a (STEP 404a). This calling component may issue that API call to API provider 430 (STEP 404b).

In some cases, a border option may be set in API monitor 440a. If such a border option is set, a user interface component in the user interface of application 410a may be highlighted (e.g., the component with which the user interacted to cause the API call to be made to the API provider). Additionally, in one embodiment, if a pause or delay has been set by the user in association with the API monitor, the API monitor 440a (e.g., the calling component of the API monitor) may wait a (e.g., configurable) time so that each (or a set of) API calls of the application 410a pauses for a number of seconds before being called or otherwise executed (STEP 406).

The API provider may return a response to this API call and this response provided to the application component that issued the API call (STEP 408). Specifically, the API response from the API provider may be received by the calling component of the API monitor 440a that issued the API call (STEP 408a). This response may include a status, a response body, or other call data. The calling component can then provide the API response to the component of the frontend application 410a that issued the API call through the calling component (STEP 408b).

Additionally, when the calling component receives this API response (STEP 408a) the calling component may store API data corresponding to the API call at the frontend (e.g., in an API call entry in call storage). This API data may include (e.g., the entire) response to the API call so that the user can review a raw response returned in response to an API call, including those API calls that occurred by the application 410a before the API monitor 440a is accessed or opened by a user. In some cases, the data stored may depend on the options set (e.g., by the user) for API monitor 440a. For example, if a “data” option is set, the entire API response may be stored. The API call data stored may also be dependent on the type of response received (e.g., if an error is returned the entire API response may be stored).

In some embodiments, API monitor 440a may filter the API calls or responses to determine if an API call entry 148a should be created for that API call. For example, API call data may only be stored for API calls to certain domains (e.g., domains associated with certain API providers such as particular enterprise computing environments) or API call data may only be stored for API calls of a certain type.

When the API response is provided to frontend application 410a (STEP 408) the application may alter the user interface of the application 410a accordingly if needed (e.g., in accordance with operation of the application 410a) (STEP 414). The component that causes the issuance of the API call can also, for example, be (un) highlighted (e.g., as the API call has been completed).

At some point then, a user may activate a display or interface of, or otherwise interact with, API monitor 440a (STEP 416). Such an interaction can be, for example, toggling an interface of API monitor 440a on or off based on options presented in an interface of application 410a or an interface into which an interface of application 410a is incorporated, such as frame or container, or the like.

In response to the activation of the API monitor interface, API monitor 440a may render an API monitor interface (STEP 418). This API monitor interface may be presented in association with the interface of the application 440a. In particular, the API monitor 440a may obtain API call entries from call storage and present the stored API calls in the API monitor interface. The API monitor interface may also allow the user to select, filter, or otherwise determine which API calls are shown in the API monitor interface, including the selection of API calls for different services, calls for different suites or classes of API calls, calls for particular API providers, etc.

As such, the API monitor interface may provide a display or list of APIs (e.g., API calls) in association with application 440a where those APIs include APIs called by the application. Additionally, the APIs presented by an API monitor 440a in the API monitor interface may be updated and displayed dynamically as these APIs are called by the application 410a.

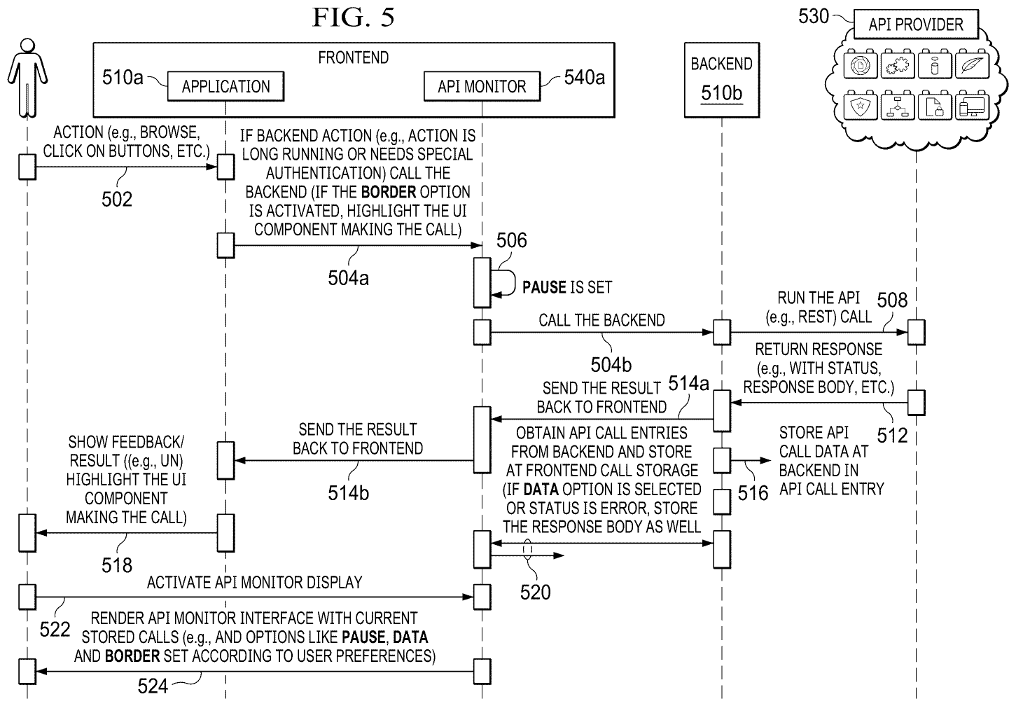

Moving now to FIG. 5, one embodiment of a method for obtaining API call data on API calls issued from a backend application 510b to an API provider 530 is depicted. Again, frontend API monitor 540a may be incorporated with (or into) frontend application 510a. A user may interact with the frontend application 510a (e.g., using a user interface or the like) (STEP 502). Based on this interaction (or otherwise) frontend application 510a may determine that the backend application 510b needs to be called (e.g., the action may be long running or need a certain type of authentication) and issue a backend call to backend application 510b. Specifically, backend calls from frontend application 510a may be received at a calling component of API monitor 540a (STEP 504a). This calling component may issue that backend call to backend 510b (STEP 504b).

As discussed, if a pause or delay has been set by the user in association with the API monitor 540a, the API monitor 540a (e.g., the calling component of the API monitor) may wait a (e.g., configurable) time so that the calls of the application 510a are paused for a number of seconds before being called or otherwise executed (STEP 506).

When backend application 510b receives the backend call from the API monitor 540a, it may issue an API call to API provider 530 in association with providing functionality for application 510. When the API provider 530 returns the response to this API call to the backend application 510b (STEP 512), the backend application may send the response back to the frontend application 514 (e.g., through the calling component of API monitor 540a (STEPS 514a, 514b). Additionally, the backend application 510b may store API data corresponding to the API call at the backend (e.g., in an API call entry in call storage). This API data may include (e.g., the entire) response to the API call (STEP 516).

When the API response is provided to frontend application 510a (STEP 514) the application 510a may alter the user interface of the application 510a accordingly if needed (e.g., in accordance with operation of the application 510a) (STEP 518). The component that causes the issuance of the API call can also, for example, be (un) highlighted (e.g., as the API call has been completed).

API monitor component 540a at the frontend application 510a may obtain API call entries associated with the application from backend 510b and store these API call entries at the frontend (STEP 520). At some interval, or when prompted through a user (or other type of) action at the frontend application 510a, a request can be sent to backend 510b. For example, such a call may be sent when a user interacts with (or opens) API monitor 540a, or may be sent at particular time intervals when frontend application 510a is running, etc.

The request from the API monitor 540a may request API call entries associated with a particular instance of a frontend application 510a. In response to receiving such an API call entry request at the backend 510b, API call entries stored at backend 510b associated with the received request (e.g., associated with the a particular instance of a frontend application 510a) may be obtained and returned to API monitor 540a. These API call entries can then be stored at the frontend (e.g., in an API call storage).

At some point then, a user may activate a display or interface of, or otherwise interact with, API monitor 540a (STEP 522). In response to the activation of the API monitor interface, API monitor 440a may render an API monitor interface (STEP 524). In particular, the API monitor 540a may obtain API call entries from call storage and present the stored API calls in the API monitor interface. As such, the API monitor interface may provide a display or list of APIs (e.g., API calls) in association with application 540a where those APIs include APIs called by backend 510b. Additionally, the APIs presented by an API monitor 540a in the API monitor interface may be updated and displayed dynamically, even when such APIs from API provider 530 are called by backend 510b.

As discussed, API calls from a backend application may also be generated without initiation from the frontend application and may be caused by a variety of circumstances, such as the expiration of a timer, the reception of certain data (e.g., an email) at the backend application, or some other trigger for an API call to an API provider by the backend. These API calls may similarly be obtained by an API monitor according to embodiments.

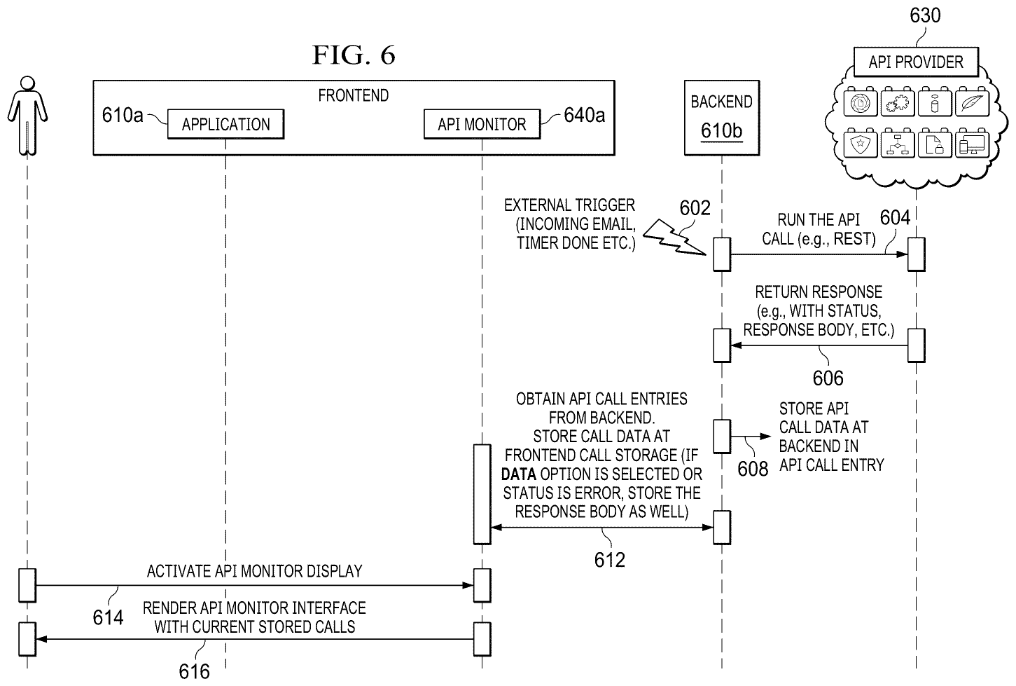

FIG. 6 depicts one embodiment of a method for obtaining API call data on API calls issued from a backend application 510b to an API provider 530 where those API calls were initiated by the backend. Here, an external trigger may be determined by backend 610b (STEP 602). Based on this trigger, the backend 610b may issue an API call to API provider 630 (STEP 604). When the API provider 630 returns the response to this API call to the backend application 610b (STEP 606), the backend application 610b may store API data corresponding to the API call at the backend (e.g., in an API call entry in call storage). This API data may include (e.g., the entire) response to the API call (STEP 608).

API monitor component 640a at the frontend application 610a may obtain API call entries associated with the application from backend 610b and store these API call entries at the frontend (STEP 612). At some interval, or when prompted through a user (or other type of) action at the frontend application 610a, a request can be sent to backend 610b. For example, such a call may be sent when a user interacts with (or opens) API monitor 640a, or may be sent at particular time intervals when frontend application 610a is running, etc.

The request from the API monitor 540a may request API call entries associated with a particular instance of a frontend application 610a. In response to receiving such an API call entry request at the backend 610b, API call entries stored at backend 610b associated with the received request (e.g., associated with the a particular instance of a frontend application 610a) may be obtained and returned to API monitor 640a, including those API calls to API provider 630 issued based on a trigger determined at the backend application 610b. These API call entries obtained from backend 610b can then be stored at the frontend (e.g., in an API call storage).

At some point then, a user may activate a display or interface of, or otherwise interact with, API monitor 640a (STEP 614). In response to the activation of the API monitor interface, API monitor 640a may render an API monitor interface (STEP 616). In particular, the API monitor 640a may obtain API call entries from call storage and present the stored API calls in the API monitor interface. As such, the API monitor interface may provide a display or list of APIs (e.g., API calls) in association with application 640a where those APIs include APIs called initiated by backend 610b in response to a trigger determined at backend 610b. Additionally, the APIs presented by an API monitor 640a in the API monitor interface may be updated and displayed dynamically, even when such APIs from API provider 530 are initiated by backend 610b (e.g., without direct involvement from frontend application 610a).

Those skilled in the relevant art will appreciate that the invention can be implemented or practiced with other computer system configurations including, without limitation, cloud deployed computing systems or server (E.g., either physical or virtual), multi-processor systems, network devices, mini-computers, mainframe computers, data processors, and the like. The invention can be embodied in a general-purpose computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Accordingly, the claims included below and the Appendix should be regarded as nonlimiting and exemplary only and should in no way be taken as a limitation or constraints on, or a complete definition of, the subject matter disclosed herein.

Rather, the description, drawings and claims are intended to describe illustrative and example embodiments, features and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods, or programs of embodiments of the invention described herein, including C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

1. A method, comprising:
executing one or more application programming interface (API) calls from an application;
storing, by a component of the application, associated API call data for each of the one or more API calls in a data structure maintained by the application;
generating, by the component of the application, an interface presenting the API call data; and
presenting the interface to a user.

2. The method of claim 1, wherein the interface presenting the API call data is presented in association with a user interface of the application.

3. The method of claim 2, wherein the API call data for an API call is associated with a portion of the user interface associated with that API call.

4. The method of claim 3, wherein the association is a visual association identifying the portion of the user interface.

5. The method of claim 1, wherein the one or more API calls comprise a backend API call or a frontend API call.

6. The method of claim 1, wherein a delay is imposed between the one or more API calls based on a user interaction with the interface presenting the API call data.

7. The method of claim 1, wherein the presented API call data for an API call is associated with documentation for an API in the interface presenting the API call data.

8. A system, comprising:
a processor; and
a non-transitory computer readable medium comprising instructions for:
executing one or more application programming interface (API) calls from an application;
storing, by a component of the application, associated API call data for each of the one or more API calls in a data structure maintained by the application;
generating, by the component of the application, an interface presenting the API call data; and
presenting the interface to a user.

9. The system of claim 9, wherein the interface presenting the API call data is presented in association with a user interface of the application.

10. The system of claim 9, wherein the API call data for an API call is associated with a portion of the user interface associated with that API call.

11. The system of claim 10, wherein the association is a visual association identifying the portion of the user interface.

12. The system of claim 8, wherein the one or more API calls comprise a backend API call or a frontend API call.

13. The system of claim 8, wherein a delay is imposed between the one or more API calls based on a user interaction with the interface presenting the API call data.

14. The system of claim 8, wherein the presented API call data for an API call is associated with documentation for an API in the interface presenting the API call data.

15. A non-transitory computer readable medium, comprising instructions for:
executing one or more application programming interface (API) calls from an application;
storing, by a component of the application, associated API call data for each of the one or more API calls in a data structure maintained by the application;
generating, by the component of the application, an interface presenting the API call data; and
presenting the interface to a user.

16. The non-transitory computer readable medium of claim 16, wherein the interface presenting the API call data is presented in association with a user interface of the application.

17. The non-transitory computer readable medium of claim 16, wherein the API call data for an API call is associated with a portion of the user interface associated with that API call.

18. The non-transitory computer readable medium of claim 17, wherein the association is a visual association identifying the portion of the user interface.

19. The non-transitory computer readable medium of claim 15, wherein the one or more API calls comprise a backend API call or a frontend API call.

20. The non-transitory computer readable medium of claim 15, wherein a delay is imposed between the one or more API calls based on a user interaction with the interface presenting the API call data.

21. The non-transitory computer readable medium of claim 15, wherein the presented API call data for an API call is associated with documentation for an API in the interface presenting the API call data.
